(19) United States
(12) Patent Application Publication
(10) Pub. No.: US 2014/0062161 A1
(43) Pub. Date: Mar. 6, 2014

(54) SEAT CUSHION HAVING AN ELECTROSPUN NONWOVEN POLYMER LAYER

(71) Applicants: Frances A. Elenbaas, Ada, MI (US); Eric B. Michalak, Nothville, MI (US)

(72) Inventors: Frances A. Elenbaas, Ada, MI (US); Eric B. Michalak, Nothville, MI (US)

(73) Assignee: Johnson Controls Technology Company, Holland, MI (US)

(21) Appl. No.: 14/009,762

(22) PCT Filed: Apr. 5, 2012
(86) PCT No.: PCT/US12/32374

§ 371 Date: Nov. 19, 2013

Related U.S. Application Data
(60) Provisional application No. 61/472,482, filed on Apr. 6, 2011.

(51) Int. Cl. B29D 99/00; A47C 7/02

(52) U.S. Cl. CPC B29D 99/0092; A47C 7/02
USPC 297/452.48; 264/415; 425/506

(57) ABSTRACT

According to various embodiments, a seat cushion includes an electrospun nonwoven polymer layer. The seat cushion may be prepared by melting a polymer, electrospinning the polymer onto a mold lid to form the nonwoven polymer layer, injecting a foam into the mold, and closing the mold lid such that the foam and the nonwoven polymer layer bond as the foam expands.

### CROSS REFERENCE TO RELATED APPLICATION

This application claims priority from and the benefit of U.S. Provisional Application Ser. No. 61/472,482, entitled “SEAT CUSHION HAVING AN ELECTROSPUN NONWOVEN POLYMER LAYER”, filed Apr. 6, 2011, which is hereby incorporated by reference in its entirety.

### BACKGROUND

The invention relates generally to a seat cushion having an electrospun nonwoven polymer layer.

Vehicle seating typically includes a seat bottom and a seat back to support a driver or passenger. In certain seating configurations, both the seat bottom and seat back include a rigid chassis, cushions, and a fabric covering. The cushions are coupled to the rigid chassis, and the fabric covering is disposed about the assembly. The rigid chassis of the seat bottom serves to support the weight (i.e., vertical load) of the passenger, and couples the seat to a floor of the vehicle. Further, the seat cushions serve to provide a comfortable surface for the passenger to sit on while in the vehicle.

Certain seat cushions are constructed by injecting liquid polyurethane into a mold to form a foam cushion having the shape of the mold cavity. In certain molding processes, a pre-fabricated polymer nonwoven layer may be placed into the mold prior to injecting the liquid polyurethane. As the polyurethane expands to fill the mold cavity, the foam will bond with the nonwoven layer to form a unitary structure. The nonwoven layer may enhance the durability of the foam cushion. Additionally, the nonwoven layer may serve to substantially reduce or eliminate unwanted noise events resulting from contact between the foam cushion and the seat bottom chassis.

Unfortunately, the process of forming the nonwoven layer and placing it in the mold may be time consuming, thereby increasing the cost associated with manufacturing the seat cushion. For example, a pre-fabricated spun-needled polypropylene (SNP) nonwoven felt layer may be manually placed in the seat cushion mold prior to injecting the foam. Pre-fabricated SNP nonwoven felt typically requires extensive preparation to form the layer into the shape of the mold cavity, thereby resulting in increased manufacturing costs. Specifically, SNP layers may require unique stitching to enable the layer to match the contours of the mold cavity, and magnets configured to hold the layer to the inner surface of the mold cavity. Consequently, as the geometric complexity of mold cavities increase, the preparation costs associated with forming the SNP layer may also increase.

### BRIEF DESCRIPTION OF THE INVENTION

The present invention relates to a cushion prepared by a process including melting a polymer and disposing the polymer inside a spinnerette, where the spinnerette is directed towards an inner surface of a metallic lid of a foam mold. The process further includes generating an electric field between the spinnerette and the metallic lid, where the electric field creates electrostatic forces acting on the polymer and cause the polymer to extrude from the spinnerette and contact the inner surface of the metallic lid forming a nonwoven fabric. The process also includes injecting a foam into the foam mold and closing the metallic lid of the foam mold such that the nonwoven fabric bonds to the foam as the foam expands.

The present invention also relates to system including a mold having an inner cavity configured to receive a foam and a mold lid configured to receive a polymer, where the mold lid is electrically coupled to an electric ground. The system further includes an electrospinning system having an extruder configured to receive a solid polymer and melt the solid polymer to create the melted polymer. The electrospinning system also includes a spinnerette configured to receive the melted polymer from the extruder, where the spinnerette is directed towards the mold lid and a high voltage supply configured to apply a voltage to the melted polymer, where applying the voltage to the melted polymer generates an electric field between the melted polymer and the mold lid.

The present invention further relates to a method of manufacturing a seat cushion including melting a polymer, disposing the polymer inside a spinnerette, where the spinnerette is directed towards an inner surface of a metallic lid of a mold. The method further includes generating an electric field between the spinnerette and the metallic lid, wherein the electric field is configured to establish electrostatic forces acting on the polymer and causing the polymer to extrude from the spinnerette and to contact the inner surface of the metallic lid forming a nonwoven fabric. The method also includes injecting a foam into the mold and closing the metallic lid of the mold such that the nonwoven fabric bonds to the foam as the foam expands.

### DRAWINGS

FIG. 1 is a perspective view of an exemplary vehicle seat which may employ a seat cushion having an electrospun nonwoven polymer layer;

FIG. 2 is an exploded perspective view of the internal structure of the seat shown in FIG. 1, including a seat cushion having an electrospun nonwoven polymer layer;

FIG. 3 is a schematic diagram of an exemplary system configured to manufacture a seat cushion having an electrospun nonwoven polymer layer; and

FIG. 4 is a flow diagram of an exemplary method for manufacturing a seat cushion having a polymer layer.

### DETAILED DESCRIPTION

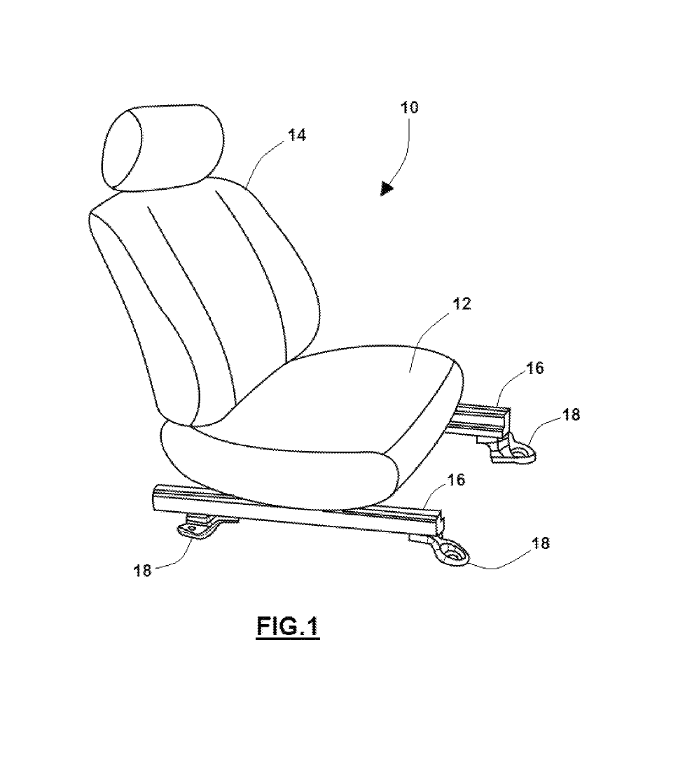

FIG. 1 is a perspective view of a vehicle seat 10. As illustrated, the seat 10 includes a seat bottom 12 and a seat back 14. In the illustrated embodiment, the seat bottom 12 includes a seat bottom chassis, one or more cushions, and a fabric covering. The seat cushion serves to provide a comfortable surface on which a passenger may sit while in the vehicle. As will be appreciated, the seat cushion is secured to the seat bottom chassis. As discussed in detail below, the seat cushion may be formed from a foam and may include an electrospun nonwoven polymer layer configured to provided added durability to the seat cushion. The polymer layer may further serve to reduce potential noise associated with contact between the seat bottom chassis and the seat cushion. The seat cushion may further include a fabric covering disposed about the cushion to provide a desired appearance and/or to protect the internal components of the seat bottom 12. The seat back 14 may be constructed in a similar manner, i.e., from one or more cushions secured to a rigid chassis and wrapped with a fabric covering.

As illustrated, the seat bottom 12 is secured to a seat track 16. The seat track 16, in turn, is secured to the floor of the vehicle by mounting feet 18. In certain configurations, the seat 10 may be configured to translate along the seat track 16 to adjust a longitudinal position of a driver or passenger. As will be appreciated, adjustment of the seating position may be either manual or assisted. For example, an electric motor may be configured to drive the seat 10 along the track 16 by a suitable mechanism such as a rack and pinion system. In addition, the seat back 14 may be configured to recline with respect to the seat bottom 12. Adjustment of the seat back 14 may also be either manual or assisted by an electric motor, for example.

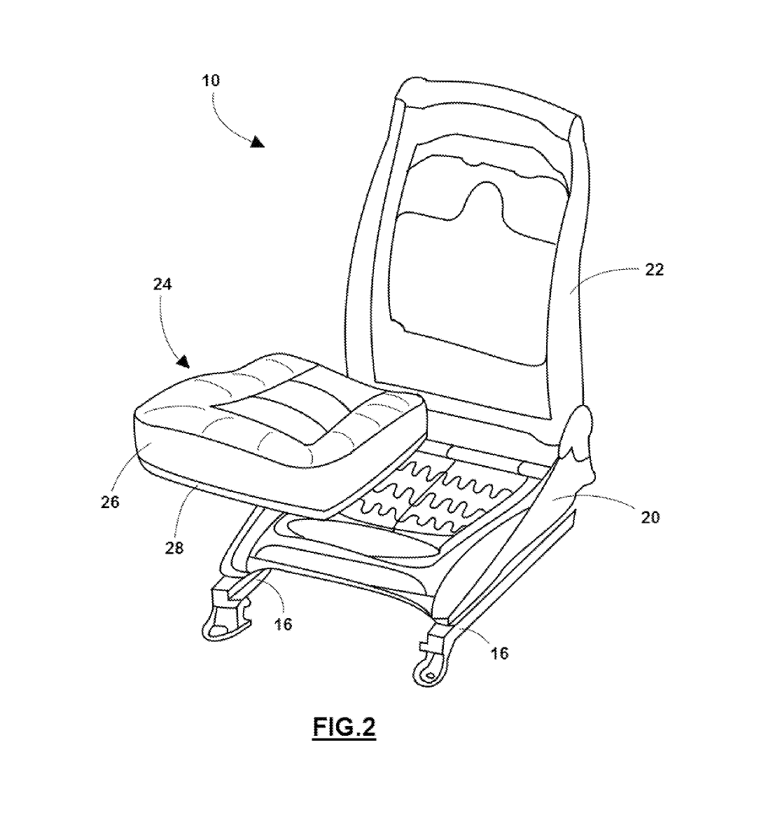

FIG. 2 is an exploded perspective view of the internal structure of the seat 10 shown in FIG. 1. As previously discussed, the seat structure is formed by a seat bottom chassis 20 and a seat back chassis 22. The seat bottom chassis 20 is mounted to the seat track 16 to secure the seat 10 to the floor of the vehicle. In the illustrated configuration, the seat bottom chassis 20 is configured for manual adjustment of the seat position along the track 16. However, alternative embodiments may include certain features that enable mounting of assisted position adjustment mechanisms, such as electric motors, gears, etc. As illustrated, the seat bottom 12 includes a seat cushion 24 which may be coupled to the seat bottom chassis 20. As shown, the seat cushion 24 has a foam layer 26 and an electrospun nonwoven polymer layer 28. As mentioned above, the foam layer 26 provides a comfortable surface on which a passenger may sit while in the vehicle. For example, the foam layer 26 may be formed from liquid polyurethane injected into a mold. The polymer layer 28 may serve to provide improved durability of the seat cushion 24, and to reduce potential noise created by contact between the seat bottom chassis 20 and the seat cushion 24. As discussed in detail below, the polymer layer 28 may be formed using an electrospinning process. The seat bottom 12 may further include a fabric covering such as cloth, vinyl or leather (not shown).

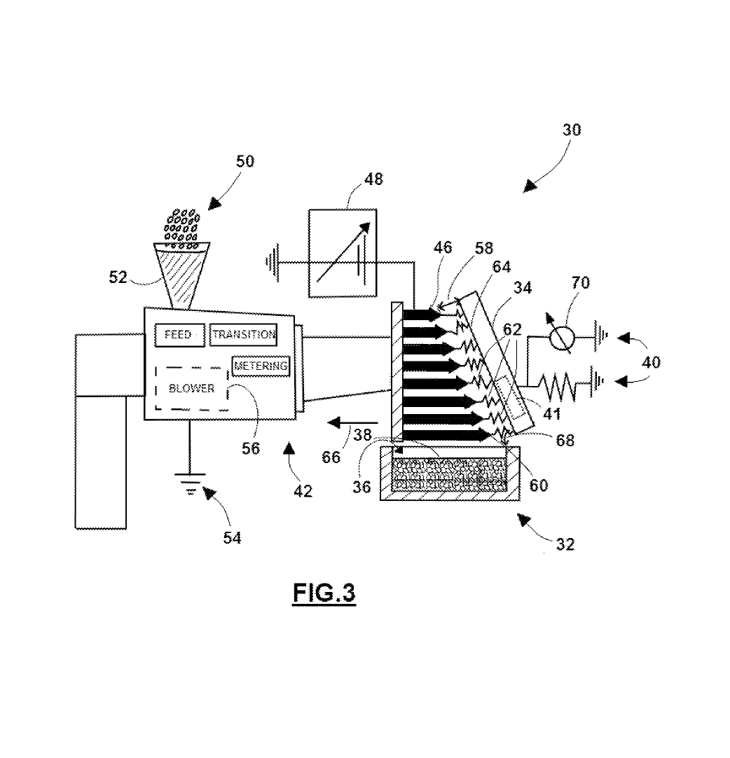

FIG. 3 is a schematic of an exemplary system 30 which may be used in manufacturing a seat cushion 24 having an electrospun nonwoven polymer layer 28. Specifically, the system 30 may be configured to use a melt electrospinning process to apply the polymer layer 28 to the foam layer 26 to form the seat cushion 24. As shown, the system 30 includes a foam mold 32 having a lid 34. In certain embodiments, the foam mold 32 and the lid 34 may be constructed from a metal, such as aluminum. The foam mold 32 includes an inner cavity 36 which forms the contours of the seat cushion 24. Specifically, a foam 38, such as liquid polyurethane, may be poured into the inner cavity 36 of the foam mold 32. As will be appreciated, the foam 38 may expand as it cures, thereby forming the foam layer 26 of the seat cushion 24. As the foam 38 cures within the inner cavity 36 of the mold 32, the polymer layer 28 may be disposed on and bonded to the foam layer 26 in the manner described below. Additionally, the lid 34 of the foam mold 32 may be electrically coupled to a reference potential 40. For example, the reference potential may be an “earth ground” or “zero volt potential.” As discussed below, the lid 34 may further include a cooling mechanism 41 such as a liquid cooled circuit or an air flow circuit.

As shown in the illustrated embodiment, the system 30 includes an electrospinning system 42. In particular, the electrospinning system 42 includes an extruder 44, one or more spinnerettes 46 and a high voltage supply 48. As will be appreciated, the electrospinning system 42 may be used to produce nano or micro scale fibers from a polymer 50. Specifically, the fibers produced by the electrospinning system 42 may be used to create a nonwoven felt mat, forming the polymer layer 28 of the seat cushion 24.

The electrospinning system 42 may receive the polymer 50, which is in the form of a liquid or of solid particles, through a polymer feed 52. In certain embodiments, the polymer 50 may be a thermoplastic or a thermoset. For example, the polymer 50 may be polypropylene or polyethylene. Moreover, the polymer 50 may comprise a wide range of molecular weights. For example, the polymer 50 may be an isotactic polypropylene with a molecular weight of 580,000, or the polymer 50 may be an atactic polypropylene with a molecular weight of 14,000. Once the polymer 50 enters the extruder 44 through the polymer feed 52, the polymer 50 may be heated and melted in a heating chamber. In certain embodiments, the heating chamber of the extruder 44 may have multiple heating zones. In one embodiment, the heating chamber may heat the polymer 50 to a temperature of approximately 200° C. The extruder 44 may be constructed from metal, and connected to a power source (not shown) and to a reference potential, such as the illustrated electrical ground 54.

After the polymer 50 is melted in the heating chamber of the extruder, the polymer 50 may be routed to the spinnerettes 46. In embodiments using a thermoset as the polymer 50, the polymer 50 may be directed to an impingement head prior to being routed to the spinnerettes 46. The polymer 50 may be delivered to the spinnerettes by one or more syringe pumps. In certain embodiments, the electrospinning system 42 may include a blower 56. As discussed below, the blower 56 may be used in a melt-blown electrospinning process. The spinnerettes 46 may comprise a variety of diameters. For example, the spinnerettes may have a diameter of approximately 1.0 mm, 1.25 mm, or 1.5 mm. As shown in the illustrated embodiment, the spinnerettes 46 are directed toward the lid 34 of the foam mold 32. Furthermore, the spinnerettes 46 may be positioned a distance 58 from the lid 34. For example, the distance 58 may be about 2 cm, 3 cm, 4cm, 5 cm, or 10 cm. Once the melted polymer 50 is inside the spinnerettes, the high voltage supply 48 will apply a voltage to the melted polymer 50. For example, the high voltage supply 48 may apply a voltage of approximately 20 kV to the melted polymer 50. As mentioned above, the lid 34 is electrically coupled to the reference potential 40. As will be appreciated, the voltage applied to the polymer 50 in the spinnerettes 46 by the high voltage supply 48 will create an electric field between the spinnerettes 46 and the lid 34. Moreover, the electrical field will cause the electrically charged polymer 50 to extrude from the spinnerettes 46 in a direction toward the lid 34. More specifically, as a voltage is applied to the polymer 50, electrostatic forces will cause the polymer 50 to form a cone shape at an apex 60 of the spinnerette 46. Thereafter, once a critical voltage is applied to the polymer 50, the viscoelastic properties of the melted polymer 50 will be overcome by the electrostatic forces produced by the electric field. As shown, the electrostatic forces will cause the polymer 50 to form fibers 62 which will travel from the spinnerettes 46 to the lid 34. In embodiments including the blower 56, a high velocity air flow produced by the blower 56 may further force the fibers 62 to travel from the spinnerettes 46 to the lid 34. As shown, the fibers 62 are collected by the lid 34 to create a nonwoven fabric 64, thereby forming the polymer layer 28. In certain embodiments, the nonwoven fabric 64 created by the fibers 62 may have at thickness of approximately 0.05 cm, 0.1 cm, 0.15 cm, 0.2 cm, or 0.25 cm.

As mentioned above, the polymer layer 28 may be disposed on and bonded to the foam layer 26. Specifically, after the fibers 62 have collected on the lid 34 and formed the nonwoven fabric 64, the foam 38 may be poured into the inner cavity 36 of the foam mold 32. Once the foam 38 has been poured, the spinnerettes 46 and the electrospinning system 42 may be retracted in a direction 66, and the lid 34 of the mold 32 may be closed, as indicated by arrow 68. Alternatively, in certain embodiments, the mold 32 may be placed on a conveyor belt passing adjacent to the spinnerettes 46 of the electrospinning system 42. Once the fibers 62 have collected on the lid 34 to form the nonwoven fabric 64, the conveyor belt may advance the foam mold 32 away from the spinnerettes 46 of the electrospinning system 42. Next, the foam 38 is poured into the inner cavity 36 of the mold 32, and the lid 34 of the foam mold 32 is closed. As the foam 38 expands, cures, and hardens, the nonwoven fabric 64 will bond to the foam 38, thereby forming the seat cushion 24. As mentioned above, the lid 34 may include a cooling mechanism 41 such as a liquid cooled or air cooled passage. The cooling mechanism 41 in the lid 34 may serve to decrease the temperature of the nonwoven fabric 64, which may help cool the nonwoven fabric 64 and help detach the fabric 64 from the lid 34. Similarly, the lid 34 may be decoupled from the reference potential 40 by an electrical switch 70, causing the electrical field to dissipate. Once the foam 38 has finished curing, the lid 34 may be opened and the resulting seat cushion 24 with the foam layer 26 and the polymer layer 28 may be removed from the mold 32.

As will be appreciated, a variety of elements may impact the melt electrospinning process detailed above. For example, polymers 50 with high molecular weights have higher viscosities. As a result, a higher voltage may be applied to the polymer 50 to create an electric field strong enough to produce fibers 62 from the polymer 50 inside the spinnerettes 46. Similarly, polymers 50 with higher molecular weights and viscosities may produce fibers 62 with greater diameters than polymers 50 with lower molecular weights and viscosities for a given voltage applied to the polymer 50. Furthermore, as mentioned above, the distance 58 between the spinnerettes 46 and the lid 34 may be particularly adjusted to achieve the desired fiber properties. As the distance 58 becomes greater, the voltage applied to the spinnerettes may be increased to provide an enhanced electric field strength.

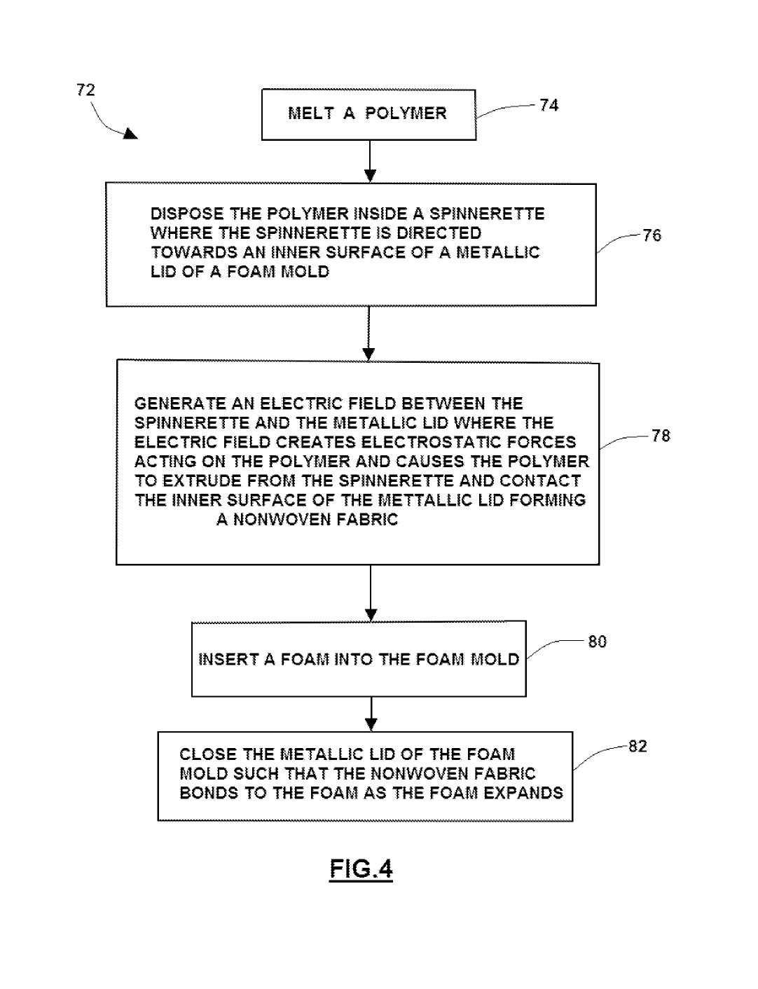

FIG. 4 is a flow diagram of an exemplary method 72 for manufacturing a seat cushion 24 having a foam layer 26 and an electrospun nonwoven polymer layer 28. First, a polymer 50 is melted, as represented by block 74. The polymer 50 may be a thermoplastic such as polyethylene or polypropylene, for example. In other embodiments, the polymer 50 may be a thermoset. Further, the polymer 50 may be melted within a heating chamber of an extruder 44. Once melted, the polymer 50 is disposed inside a spinnerette 46, where the spinnerette 46 is directed towards an inner surface of a metallic lid 34 of a foam mold 32, as represented by block 76. For example, the metallic lid 34 may be constructed from aluminum. In certain embodiments, the metallic lid 34 may also be cooled by a liquid cooling or air cooling mechanism 41. The mold 32 may include an inner cavity 36 that forms the shape of a seat cushion 24. Additionally, certain embodiments may include more than one spinnerette 46. Thereafter, an electric field is generated between the spinnerette 46 and the metallic lid 34, as represented by block 78. More specifically, the electric field creates electrostatic forces acting on the polymer 50 and causing the polymer 50 to extrude from the spinnerette 46 and to contact the inner surface of the metallic lid 34, thereby forming a nonwoven fabric 64. The electric field is generated by using a high voltage supply 48 to apply a voltage to the polymer 50 inside the spinnerette 46. Additionally, the metallic lid 34 is electrically coupled to a reference potential 40. As the polymer 50 extrudes from the spinnerette 46 in the form of fibers 62, and the fibers 62 are collected on the metallic lid 34, the fibers 62 will form the nonwoven fabric 64. The fibers 62 may vary in diameter based on factors such as the molecular weight of the polymer 50, the strength to the electric field, and the distance 58 between the spinnerette 46 and the metallic lid 34, among other factors.

As represented by block 80, a foam 38 may be injected into the mold 32. In particular, the foam 38 may be injected into the inner cavity 36 of the mold 32. In certain embodiments, the foam 38 may be a liquid polyurethane. Once the foam 38 is injected into the inner cavity 36 of the foam mold 32, the metallic lid 34 is closed, thereby enabling the nonwoven fabric 64 to bond to the expanding foam 38, as represented by block 82. More particularly, once the lid 34 is closed, the nonwoven fabric 64 may contact the foam 38 and bond with the foam 38 as the foam 38 expands, hardens, and cures. Thereafter, the lid 34 may be opened, and the formed seat cushion 24 having a foam layer 26 and an electrospun nonwoven polymer layer 28 may be removed.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A cushion prepared by a process comprising:
melting a polymer;
disposing the polymer inside a spinnerette, wherein the spinnerette is directed toward an inner surface of a metallic lid of a mold;
generating an electric field between the spinnerette and the metallic lid, wherein the electric field is configured to establish electrostatic forces acting on the polymer and causing the polymer to extrude from the spinnerette and to contact the inner surface of the metallic lid forming a nonwoven fabric;
injecting a foam into the mold; and
closing the metallic lid of the mold such that the nonwoven fabric bonds to the foam as the foam expands.

2. The product of the process of claim 1, wherein the polymer comprises a thermoplastic.

3. The product of the process of claim 1, wherein the polymer comprises a thermoset.

4. The product of the process of claim 1, wherein generating the electric field comprises applying a voltage to the polymer and electrically coupling the metallic lid to a reference potential.

5. The product of the process of claim 1, comprising providing an airflow about the spinnerette and directed toward the metallic lid.

6. The product of the process of claim 1, wherein the metallic lid comprises aluminum.

7. The product of the process of claim 1, wherein the foam comprises a liquid polyurethane.

8. The product of the process of claim 1, wherein melting the polymer comprises disposing the polymer in an extruder having a heating chamber.

9. The product of the process of claim 8, wherein the heating chamber includes a feed zone, a transition zone, and a metering zone.

10. The product of the process of claim 1, wherein disposing the polymer inside the spinnerette comprises controlling a flow of the polymer with a syringe pump.

11. A system, comprising:
a mold, comprising:
an inner cavity configured to receive a foam; and
a mold lid configured to receive a melted polymer, wherein the mold lid is electrically coupled to a reference potential; and
an electrospinning system, comprising:
an extruder configured to melt a solid polymer to create the melted polymer;
a spinnerette configured to receive the melted polymer, and to direct the melted polymer toward the mold lid; and
a high voltage supply configured to apply a voltage to the melted polymer to establish an electric field between the melted polymer and the mold lid.

12. The system of claim 11, wherein the polymer is a thermoplastic.

13. The system of claim 11, wherein the polymer is a thermoset.

14. The system of claim 11, wherein the mold lid is cooled by a liquid or a gas.

15. The system of claim 11, comprising a blower configured to direct air through the spinnerette.

16. The system of claim 11, wherein the foam comprises a liquid polyurethane.

17. A method, comprising:
melting a polymer;
disposing the polymer inside a spinnerette, wherein the spinnerette is directed toward an inner surface of a metallic lid of a mold;
generating an electric field between the spinnerette and the metallic lid, wherein the electric field is configured to establish electrostatic forces acting on the polymer and causing the polymer to extrude from the spinnerette and to contact the inner surface of the metallic lid forming a nonwoven fabric;
injecting a foam into the mold; and
closing the metallic lid of the mold such that the nonwoven fabric bonds to the foam as the foam expands.

18. The method of claim 17, comprising cooling the metallic lid with a liquid or gas.

19. The method of claim 17, comprising forcing air through the spinnerette.

20. The method of claim 17, wherein the polymer comprises a thermoplastic or a thermoset.
